(19) United States
(12) Patent Application Publication
(10) Pub. No.: US 2004/0153498 A1
(43) Pub. Date: Aug. 5, 2004

(54) Content delivery apparatus and method of controlling content delivery

(75) Inventors: Takayuki Nakajima, Yokohama-shi (JP); Miyuki Kameyama, Matsudo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc, Tokyo (JP)

(21) Appl. No.: 10/762,235

(22) Filed: Jan. 23, 2004

(30) Foreign Application Priority Data
Jan. 24, 2003 (JP) 2003-015892

(51) Int. Cl. G06F 15/16

(52) U.S. Cl. 709/201

(57) ABSTRACT

The present invention includes a transmitting/receiving unit which acquires contents associated with a piece of time information including a predetermined time from a content management server when the predetermined time has elapsed; and an accepting unit which allows the user to input delivery information for delivering a selected content. Based on the delivery information inputted at the accepting unit, the transmitting/receiving unit delivers the selected content to a delivery destination indicating a terminal which is included in the delivery information. The content associated with each piece of the time information is displayed in such a manner that displayed scenery varies with a time included in the associated piece of the time information.

### CROSS REFERENCE TO RELATED APPLICATIONS

This application is based upon and claims the benefit of priority from the prior Japanese Patent Application No. P2003-15892, filed on Jan. 24, 2003; the entire contents of which are incorporated herein by reference.

### BACKGROUND OF THE INVENTION

1. Field of the Invention

The present invention relates to a content delivery apparatus which delivers a content managed by a content management server to a terminal, and a method of controlling content delivery.

2. Description of the Related Art

A system has hitherto been proposed in which a delivery server acquires a piece of advertising information from a management server that manages the advertising information including shop advertisements, and in response to a request from a terminal, delivers the acquired piece of advertising information to the terminal (for example, Patent Literatures 1 and 2).

Patent Literature 1: Japanese Patent Laid Open Publication No. 2002-9691 (Pages 5 to 10, FIG. 1)

Patent Literature 2: Japanese Patent Laid Open Publication No. 2002-7253 (Pages 7 to 11, FIG. 1)

However, in the above conventional system, the delivery server only acquires advertising information present in the management server for an arbitrary time period and does not acquire contents according to a specific time period from the management server. Specifically, in the morning hours for example, the delivery server did not acquire contents required in the morning hours (information on a shop which offers a morning meal, etc.) from the management server. Therefore, users could not quickly acquire contents most relevant to the present time.

Moreover, the delivery server sends contents to terminals irrespective of a type of terminal. Therefore, the delivery server could not change a content to be delivered, according to a service (xx mode, etc.) executable by each terminal. Furthermore, some of the terminals which were to receive contents from the delivery server could not instantaneously acquire a relevant content because of the conditions of communication lines thereof.

### SUMMARY OF THE INVENTION

Therefore, the present invention was made in the light of the aforementioned points, and an object thereof is to provide a content delivery apparatus and a method of controlling content delivery, which can change a content to be acquired from a management server, according to time, and which can change the contents of the acquired content and the size thereof, according to the type of a terminal and the capacity of a communication line between the terminal and the content delivery apparatus.

Specifically, in delivering a content managed by the content management server to a terminal, a first aspect of the present invention is characterized in that the content management server stores in advance a plurality of contents and a plurality of pieces of time information associated with the contents, and that when a predetermined time elapses, the content delivery apparatus acquires contents associated with a piece of the time information including the predetermined time from the content management server; displays the acquired contents in such a manner that each of the contents is selectable by an operation instruction of a user; accepts delivery information including a delivery destination indicating a terminal to which a selected content is delivered; and, based on the accepted delivery information, delivers the selected content to the delivery destination which is included in the accepted delivery information. Preferably, the contents associated with the respective pieces of time information are displayed in such a manner that displayed sceneries vary depending on times included in the associated pieces of time information.

In delivering a content managed by the content management server to a terminal, a second aspect of the present invention is characterized in that the content management server stores in advance a plurality of contents and a plurality of pieces of terminal information including headers of the contents and types of terminals, and that the content delivery apparatus displays the headers corresponding to the contents in such a manner that each of the headers is selectable by an operation instruction of a user; accepts delivery information including a delivery destination indicating a terminal to which a content corresponding to a selected header is delivered and including the type of the terminal; based on the type included in the accepted delivery information, identifies a piece of terminal information which matches the selected header and the type among the pieces of terminal information; acquires a content associated with the identified piece of terminal information from the content management server; changes the size of the acquired content according to the capacity of a communication line of the terminal; and delivers the changed content to the delivery destination included in the accepted delivery information. Preferably, the contents are local information concerning the area in which the content delivery apparatus is deployed.

### BRIEF DESCRIPTION OF DRAWINGS

FIG. 1 is a view showing a schematic configuration of a content delivery system according to an embodiment.

FIG. 2 is a view showing an internal configuration of the content delivery system according to the embodiment.

FIG. 3 is a table showing the contents of time information and contents stored in a content management server in the embodiment.

FIG. 4 is a table showing the contents of terminal information and contents stored in the content management server in the embodiment.

FIG. 5 is a view showing the contents of a screen displayed on a display unit in the embodiment.

FIG. 6 is a chart showing a procedure of a method of controlling content delivery according to the embodiment (Case 1).

FIG. 7 is a chart showing a procedure of the method of controlling content delivery according to the embodiment (Case 2).

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of devices, it will be appreciated that the various drawings are not drawn to scale from one figure to another not inside a given figure.

In the following descriptions, numerous specific details are set forth such as specific signal values, etc. to provide a thorough understanding of the present invention. However, it will be obvious to those skilled in the art that the present invention may be practiced without such specific details.

(Basic Configuration of Content Delivery Apparatus)

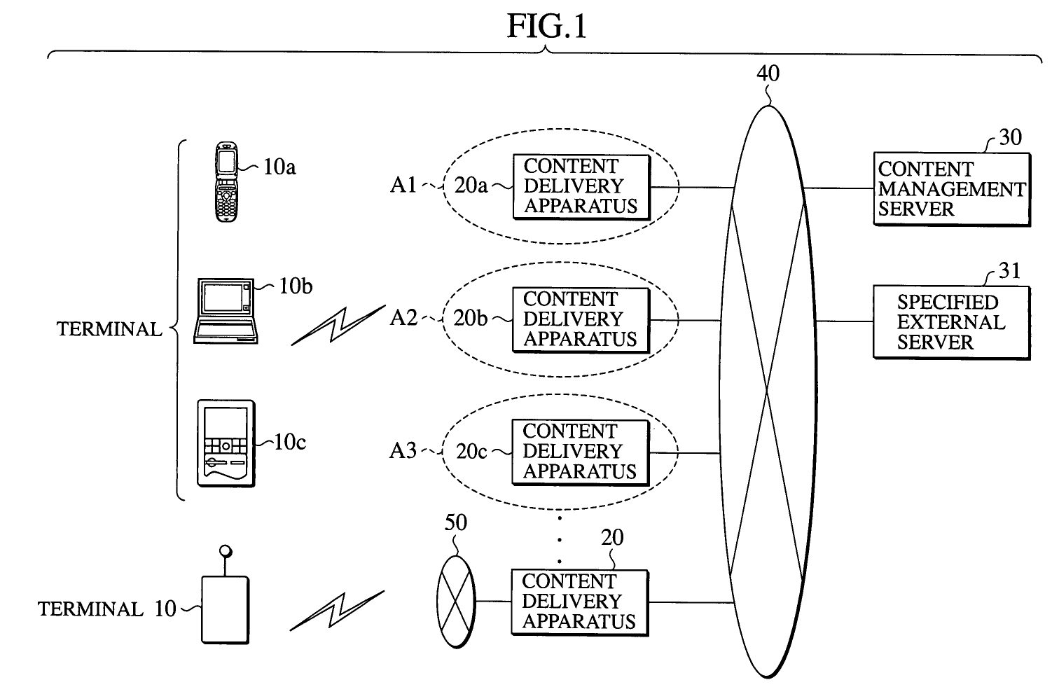

A description will be given of a content delivery apparatus 20 according to the present invention with reference to the drawings. FIG. 1 is a schematic view of the configuration of a content delivery system according to an embodiment.

As shown in FIG. 1, the content delivery apparatus 20 is connected to a content management server 30 through a communication network 40 and deployed in an area to and from which a plurality of users can come and go. The content management server 30 manages a plurality of contents including letters and characters, or images. The content delivery apparatus 20 delivers a content managed by the content management server 30 to a terminal 10.

The terminal 10 and the content delivery apparatus 20 may be connected to a public network 50 as shown in FIG. 1. This enables the terminal 10 to acquire a relevant content through the general public network 50 from the content management server 30 connected to the communication network 40.

In this embodiment, the content delivery system includes terminals 10a to 10c, content delivery apparatuses 20a to 20c respectively deployed in areas A1 to A3, and the content management server 30. Preferably, the areas A1 to A3 are communication spaces in a station, a bus terminal, an airport, and the like.

In this embodiment, the content management server 30 includes a transmitting/receiving unit 31, a content management controller 32, and a content database 33. The transmitting/receiving unit 31 sends and receives data to and from a transmitting/receiving unit 21. The content management controller 32 controls the entire content management server 30. The content database 33 stores the plurality of contents including letters and characters, or images.

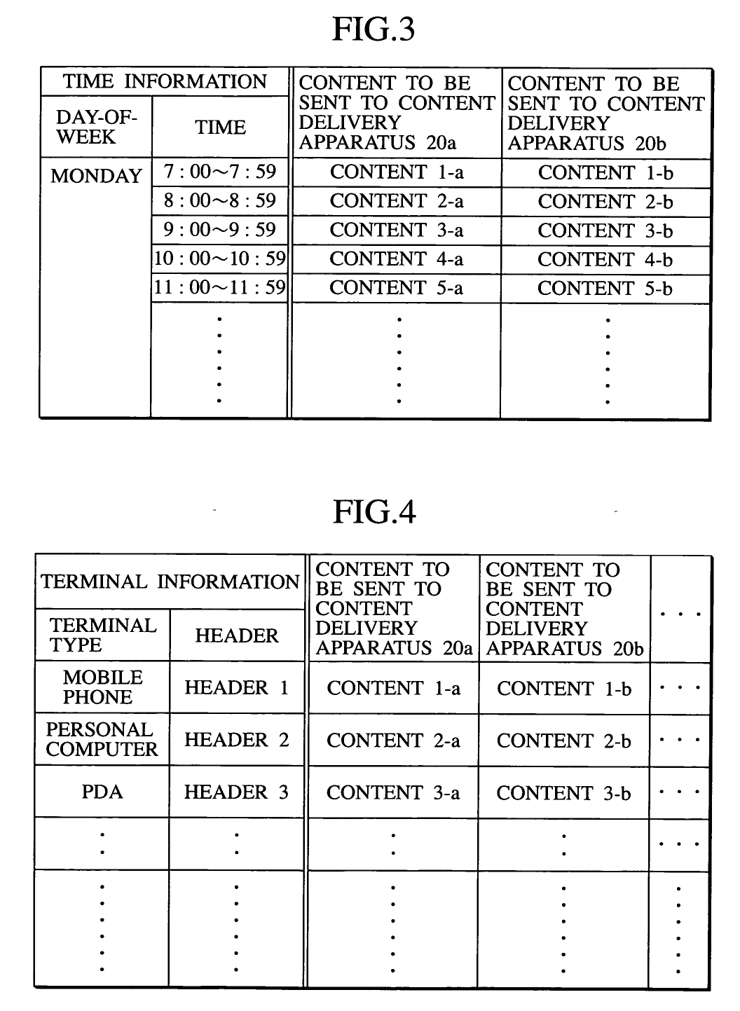

As shown in FIG. 3, each content stored in the content database 33 is associated with a piece of time information including a time, a date, a day of the week, or a time period of the day. As a specific example, the “days of the week” and the “times (time periods)” are associated with respective contents 1-a, 2-a, 3-a . . . . In this embodiment, time information of “7:00 to 7:59” includes times such as “7:05,” for example.

If a time included in a piece of time information is in the morning, examples of the content associated with the piece of time information are information concerning breakfast and the like. On the other hand, if a time included in a piece of time information is in the evening, examples of the content associated with the piece of time information are information concerning an evening meal and the like.

The contents 1-a, 2-a, 3-a . . . , contents 1-b, 2-b, 3-b . . . , and so on are stored in the content database 33 for the respective content delivery apparatuses 20a, 20b, and so on.

As shown in FIG. 4, each content stored in the content database 33 may be associated with a piece of terminal information including a content header and a type of the terminal 10. Examples of the type of the terminal 10 are a mobile phone 10a, a personal computer 10b, a PDA 10c, and the like. This terminal information may include the time information.

Preferably, each content is local information concerning the area in which the content delivery apparatus 20 is located. Examples of this information are a map, a store advertisement, and the like. The content associated with each piece of time information may be displayed in such a manner that displayed scenery varies depending on a time included in the associated piece of the time information.

For example, if a time included in a piece of time information is seven o' clock in the morning, the content associated with the piece of time information can be a map with bright scenery. If a time included in a piece of time information is eleven o' clock in the evening, the content associated with the piece of time information can be a map with dark scenery.

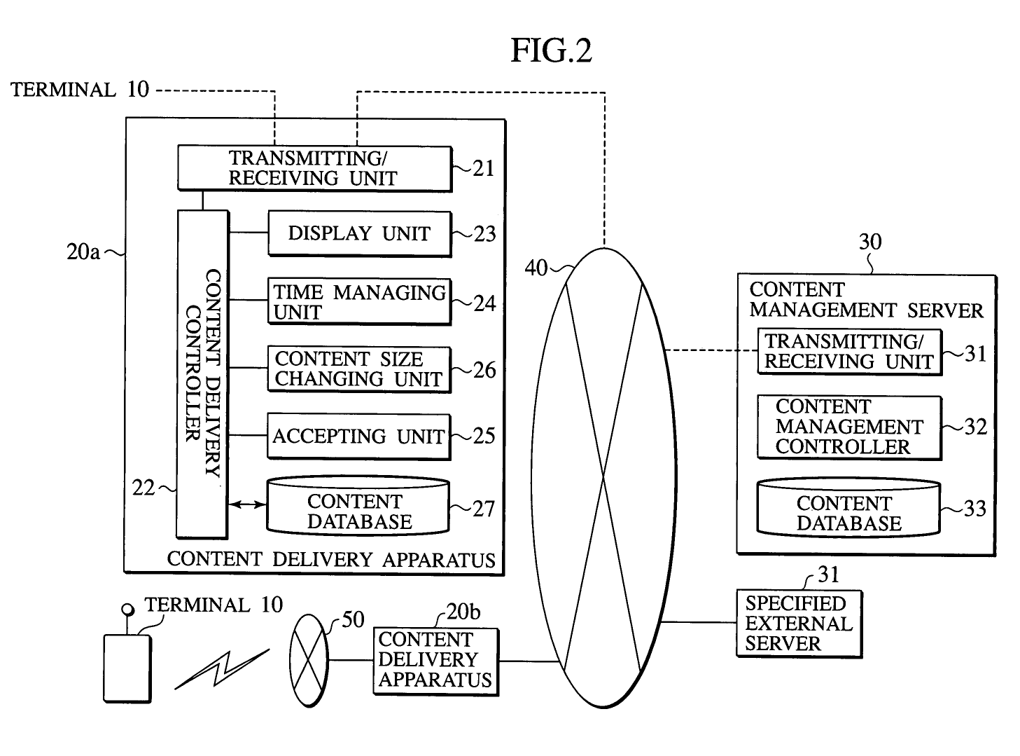

In this embodiment, the delivery apparatus 20 includes the transmitting/receiving unit 21 (accepting unit, delivering unit), a content delivery controller 22 (content acquiring unit), a display unit 23 (display unit), a time managing unit 24, an accepting unit 25 (accepting unit), a content size changing unit 26 (size changing unit), and a content database 27 (see FIG. 2). The transmitting/receiving unit 21 sends and receives data to and from the transmitting/receiving unit 31.

The content database 27 temporarily stores contents acquired by the transmitting/receiving unit 21. The time managing unit 24 manages time and date. The accepting unit 25 accepts delivery information for delivering a content selected by an operation instruction of a user. This delivery information includes a delivery destination (telephone number) indicating the terminal 10 owned by the user, a user's password, an identification of the user, the terminal type, or the like. The transmitting/receiving unit 21 may acquire the delivery information from the terminal 10.

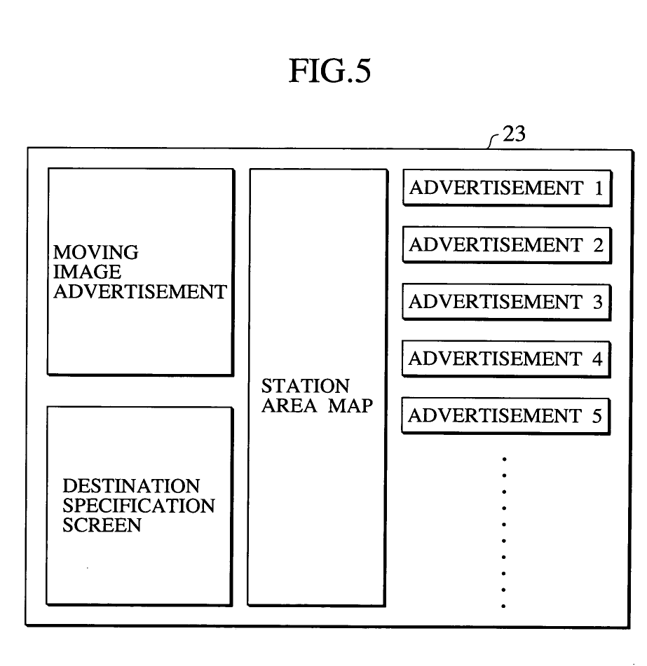

The content delivery controller 22 acquires contents (or headers) associated with a piece of time information including a predetermined time, from the content management server 30 through the transmitting/receiving unit 21 when the predetermined time has elapsed. The display unit 23 displays the contents (or the headers) acquired by the content delivery controller 22 in such a manner that each content is selectable by an operation instruction of a user (see FIG. 5).

The user selects one of the contents displayed on the display unit 23. Examples of the display unit 23 are a touch panel where a user can select a content displayed on the display unit 23 by touching the content, and the like. A section by which a content can be selected may be provided separately from the display unit 23. Moreover, the accepting unit 25 may accept at least one of the headers displayed on the display unit 23 in such a manner so as to be selectable according to on operation instruction by the user.

The display unit 23 is not limited to being used in the content delivery apparatus 20 deployed in the area (especially, a station) to and from which a plurality of users can come and go, but may also be installed in, for example, household appliances; desktop, indoor, and outdoor billboards for shop promotion; billboards for home sales; electronic menus (tablet PC, etc.); car navigation systems; indoor guide boards; automatic vending machines; and the like. Provided in household appliances or the like, the display unit 23 can be used not only for displaying guides for shops located near a station, destination signs, or the like, but also for displaying advertisements of household appliances or the like.

Based on the type of the terminal 10 which is included in the delivery information accepted by the accepting unit 25 or in the delivery information acquired by the transmitting/receiving unit 21, and based on the header (header after selection) selected at the display unit 23, the content delivery controller 22 acquires a content associated with a piece of terminal information which matches the type of the terminal 10 and the header.

The content size changing unit 26 changes the size of the content which has been acquired by the transmitting/receiving unit 21 or the content delivery controller 22, according to the capacity of a communication line of the terminal 10. Specifically, the content size changing unit 26 determines the capacity (for example, 64 Kbps, etc.) of the communication line set between the transmitting/receiving unit 21 and the terminal 10.

The content size changing unit 26 which has determined the size of the communication line determines a compression rate of the content acquired by the transmitting/receiving unit 21, according to the determined capacity of the communication line. The content size changing unit 26 which has determined the compression rate compresses the content acquired by the transmitting/receiving unit 21 using the determined compression rate. That is, the content size changing unit 26 changes the size of the content.

Based on the delivery destination indicating the terminal 10, which is included in the delivery information inputted by the accepting unit 25, the transmitting/receiving unit 21 delivers the content selected at the display unit 23 to the delivery destination. Moreover, based on the destination indicating the terminal 10, which is included in the delivery information inputted by the accepting unit 25, the transmitting/receiving unit 21 delivers the content the size of which has been changed by the content size changing unit 26, to the delivery destination.

(Method of Controlling Content Delivery using Content Delivery Apparatus)

A method of controlling content delivery using the content delivery apparatus having the aforementioned configuration is implemented by the following procedures.

(1) Procedure until the content delivery apparatus 20 displays relevant contents on the display unit 23 when it is past a predetermined time and a user acquires one of the contents displayed on the display unit 23 through the terminal 10

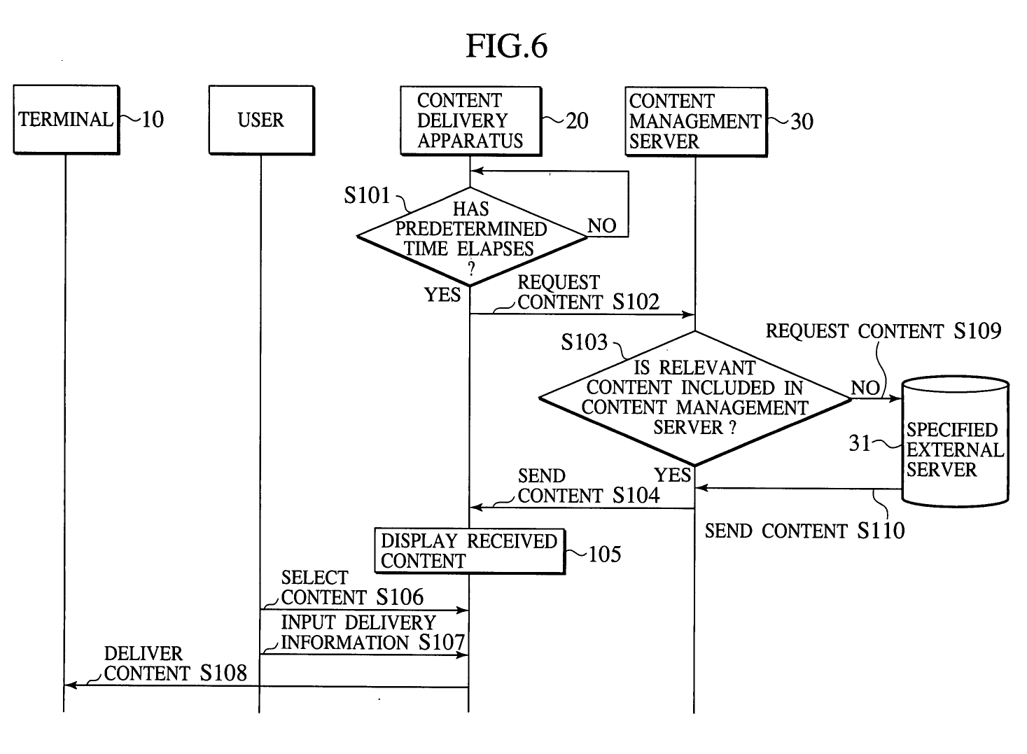

FIG. 6 is a chart showing a procedure until the content delivery apparatus 20 displays relevant contents on the display unit 23 when it is past a predetermined time and a user acquires one of the contents displayed on the display unit 23 through the terminal 10. As shown in FIG. 6, first, the content delivery controller 22 detects that it is past a specified time managed by the time managing unit 24 (S101). Based on the specified time, this content delivery controller 22 sends the transmitting/receiving unit 31 request information for acquiring contents associated with the specified time (S102).

Based on the time included in the request information received by the transmitting/receiving unit 31, the content management controller 32 acquires the contents associated with the time from the content database 33 (S103). When this content management controller 32 acquires from the content database 33 the contents associated with the time included in the received request information, the content management controller 32 sends the acquired contents to the content delivery controller 22 (S104).

On the contrary, when the content management controller 32 cannot acquire the contents associated with the time included in the received request information, the content management controller 32 connects with another specified external server 31 deployed in the communication network 40. The content management controller 32 then acquires the contents associated with the time included in the received request information, from the specified external server 31 with which the content management controller 32 is connected (S109, S110). The content management controller 32 sends the acquired contents to the content delivery controller 22 (S104). Preferably, the specified external server 31 stores information which is not included in the content management server 30 or data which cannot be held by the content management server 30.

When an identifier, which is issued in advance by the content database 33, is included in the request information received from the terminal 10, the content delivery controller 22 may acquire a specific content associated with the identifier from the content database 33 or the specified external server 31.

Accordingly, the content database 33 can change the contents of a content according to whether or not the identifier is included in the received request information. For example, when the identifier is included in the request information, the contents of a content can be changed to be unique information.

Subsequently, the content delivery controller 22 acquires the sent contents through the transmitting/receiving unit 21. The content delivery controller 22 displays the acquired contents on the display unit 23 (S105). A user selects a desired content from among the contents displayed on the display unit 23 (S106). At this time, the user inputs delivery information for delivering the content, through the accepting unit 23 (S107).

Subsequently, based on the delivery information inputted from the accepting unit 25 or delivery information received from the terminal 10, the transmitting/receiving unit 21 delivers the content selected at the display unit 23 to a delivery destination indicating the terminal 10 included in the delivery information (S108).

Based on the delivery information inputted from the accepting unit 25 or the delivery information received from the terminal 10, the transmitting/receiving unit 21 checks certification information included in the delivery information against each piece of authentication information stored in advance. When a piece of authentication information which matches the certification information is identified, the transmitting/receiving unit 21 preferably delivers the content acquired from the content management server 30 to the delivery destination included in the received delivery information (the same applies to an undermentioned procedure (2)).

Examples of this certification information are an ID for identifying a user, a password, a mobile phone number, and the like. With this certification information, the content delivery apparatus 20 can provide a relevant content only to a user with specific certification information.

(2) Procedure until the content delivery apparatus 20 delivers a relevant content according to the type of the terminal 10

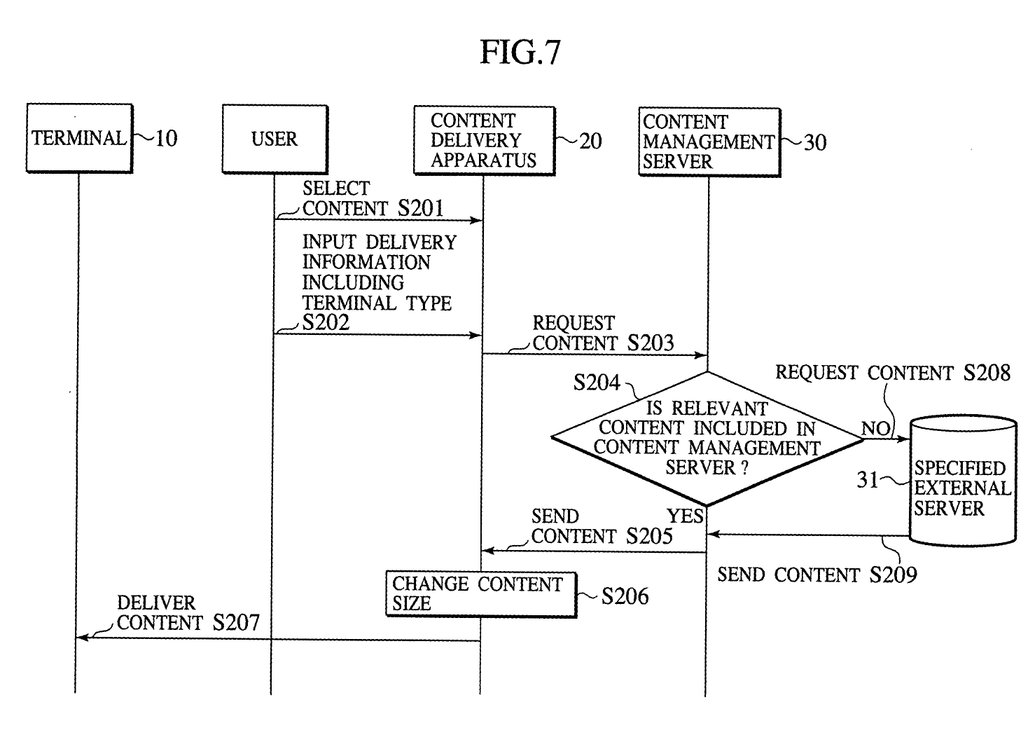

FIG. 7 is a chart showing a procedure until the content delivery apparatus 20 delivers a relevant content according to the type of the terminal 10. As shown in FIG. 7, a user selects at least one header from among headers displayed on the display unit 23 (S201). Moreover, the user inputs delivery information through the accepting unit 25 (S202). The terminal 10 may send delivery information to the transmitting/receiving unit 21 according to an operation input by the user.

Based on the type of the terminal 10 which is included in the delivery information accepted by the accepting unit 25 or in the delivery information received by the transmitting/receiving unit 21, and based on the header (header after selection) selected at the display unit 23, the content delivery controller 22 sends the transmitting/receiving unit 31 request information for acquiring a content associated with a piece of terminal information which matches the type of the terminal 10 and the header (S203).

Subsequently, based on the request information received by the transmitting/receiving unit 31, the content management controller 32 identifies the piece of terminal information which matches the type of the terminal 10 and the header included in the request information, from the content database 33 (S204). When this content management controller 32 acquires the content associated with the identified piece of terminal information from the content database 33, the content management controller 32 sends the acquired content to the content delivery controller 22 (S205).

However, when the content management controller 32 cannot acquire from the content database 33 the content associated with the piece of terminal information which matches the type of the terminal 10 and the header included in the received request information, the content management controller 32 connects with another specified external server 31 deployed in the communication network 40.

This content management controller 32 acquires the content associated with the piece of terminal information which matches the type of the terminal 10 and the header, from the specified external server 31 with which the content management controller 32 is connected (S208, S209). The content management controller 32 sends the acquired content to the content delivery controller 22 (S205).

Subsequently, the content size changing unit 26 changes the size of the content acquired by the content delivery controller 22, according to the capacity of a communication line of the terminal 10 (S206). Specifically, the content size changing unit 26 determines the capacity (for example, 64 Kbps, etc.) of the communication line set between the transmitting/receiving unit 21 and the terminal 10.

The content size changing unit 26 which has determined the capacity of the communication line determines a compression rate of the content acquired by the transmitting/receiving unit 21, according to the determined capacity of the communication line. The content size changing unit 26 which has determined the compression rate compresses the content acquired by the transmitting/receiving unit 21 using the determined compression rate. Subsequently, based on a delivery destination indicating the terminal 10 which is included in the delivery information inputted at the accepting unit 25, the transmitting/receiving unit 21 delivers the content compressed by the content size changing unit 26 to the delivery destination (S207).

(Operation and Effect of Content Delivery Apparatus and of Method of Controlling Content Delivery)

According to the present invention of this application, when a predetermined time has elapsed, the content delivery unit 22 can acquire from the content management server 30 contents associated with a piece of time information including the predetermined time and display the acquired contents on the display unit 23. Accordingly, if the contents displayed on the display unit 23 is information especially required for the present time, a user can instantaneously acquire required information at the present time from the contents through a terminal 10 of his/her own.

Since the scenery contained in the contents varies with time, the user can acquire the required information at the present time through the terminal 10 of his/her own while visually perceiving the present time.

The content delivery controller 22 can identify the piece of terminal information which matches the type of the terminal 10 and the selected header, and can acquire the content associated with the identified piece of terminal information from the content management server 30. This enables the content delivery controller 22 to deliver the relevant content to the terminal 10 according to a service executable by the type of the terminal 10.

The content delivery controller 22 can change the size of the content acquired from the content management server 30 according to the capacity of the communication line of a terminal 10. Accordingly, even when the communication capability of the terminal 10 to which the content is delivered is low, the content delivery controller 22 can change the size of the content according to the capacity of the communication line of the terminal 10. Therefore, the terminal 10 can instantaneously acquire the relevant content from the content delivery apparatus 20.

Since the contents is local information concerning the area in which the content delivery apparatus 20 is deployed, users can instantaneously acquire information on the areas surrounding the content delivery apparatus 20.

Various modifications will become possible for those skilled in the art after receiving the teachings of the present disclosure without departing from the scope thereof.

What is claimed is:

1. A content delivery apparatus which delivers a content managed by a content management server to a terminal, the content management server storing in advance a plurality of the contents and a plurality of pieces of time information associated with the contents, the content delivery apparatus comprising:
a content acquiring unit which, when a predetermined time has elapsed, acquires relevant contents associated with a piece of time information including the predetermined time from the content management server;
a display unit which displays the relevant contents acquired by the content acquiring unit in such a manner that each of the contents is selectable according to an operation instruction by a user;
an accepting unit which accepts delivery information including a delivery destination indicating the terminal to which selected one of the relevant contents is delivered; and
a delivering unit which delivers the selected content to the delivery destination that is included in the delivery information accepted by the accepting unit,
wherein the content associated with each piece of time information is displayed in such a manner that displayed scenery varies with a time included in the associated piece of time information.

2. A content delivery apparatus which delivers a content managed by a content management server to a terminal, the content management server storing in advance a plurality of contents and a plurality of pieces of terminal information including headers of the contents and types of the terminals, the content delivery apparatus comprising:
a display unit which displays the headers corresponding to the contents in such a manner that each of the headers is selectable by an operation instruction of a user;
an accepting unit which accepts delivery information including a delivery destination indicating one of the terminals to which a relevant content corresponding to a selected one of the headers is delivered and including the type of the terminal;
a content acquiring unit which, based on the type that is included in the delivery information accepted by the accepting unit, identifies a piece of the terminal information that matches the selected header and the type from among the pieces of the terminal information, and acquires the relevant content associated with the identified piece of the terminal information from the content management server;
a size changing unit which changes a size of the content acquired by the content acquiring unit according to a capacity of a communication line of the terminal; and
a delivering unit which delivers the content the size of which is changed by the size changing unit, to the delivery destination included in the delivery information accepted by the accepting unit.

3. The content delivery apparatus according to any of claims 1 and 2, wherein the contents are local information concerning an area in which the content delivery apparatus is deployed.

4. A method of controlling content delivery using a content delivery apparatus which delivers a content managed by a content management server to a terminal, the content management server storing in advance a plurality of contents and a plurality of pieces of time information associated with the contents, said method comprising:
a first step of acquiring, when a predetermined time has elapsed, relevant contents associated with a piece of time information including the predetermined time from the content management server;
a second step of displaying the relevant contents acquired in the first step in such a manner that each of the contents is selectable according to an operation instruction by a user;
a third step of accepting a delivery destination indicating the terminal to which a selected one of the relevant contents is delivered; and
a fourth step of delivering the selected content to the delivery destination which is included in the delivery information accepted in the third step,
wherein the content associated with each piece of the time information is displayed in such a manner that displayed scenery varies with a time included in the associated piece of the time information.
